(19) United States
(12) Patent Application Publication
(10) Pub. No.: US 2015/0318939 A1
(43) Pub. Date: Nov. 5, 2015

(54) RELAY DEVICE, RELAY METHOD, AND RELAY PROGRAM

(71) Applicants: Yohei TSUKAMOTO, (US); MITSUBISHI ELETRIC CORPORATION, Chiyoda-ku, Tokyo (JP)

(72) Inventor: Yohei TSUKAMOTO, Tokyo (JP)

(73) Assignee: Mitsubishi Electric Corporation, Chiyoda-ku, Tokyo (JP)

(21) Appl. No.: 14/650,638

(22) PCT Filed: Feb. 27, 2013
(86) PCT No.: PCT/JP2013/055061

§ 371 Date: Jun. 9, 2015

(51) Int. Cl. H04J 3/06; H04L 25/44; H04B 7/15

(52) U.S. Cl. CPC H04J 3/06; H04B 7/15; H04L 25/44

(57) ABSTRACT

A fixed delay time storage unit 270 stores a fixed delay time 271 which is predetermined as a time equal to or greater than a time required for transmission of a regular frame. A frame receiving unit 210 receives a synchronization frame. A buffer unit 220 stores the received synchronization frame. A fixed time delay unit 260 measures an elapsed time from receipt of the synchronization frame, and determines whether or not the measured elapsed time has reached the fixed delay time 271. When it is determined that the elapsed time has reached the fixed delay time 271, a frame transmission unit 230 transmits the synchronization frame stored in the buffer unit 220.

### TECHNICAL FIELD

The present invention relates to, for example, a relay device, a relay method, and a relay program for relaying a synchronization frame.

### BACKGROUND ART

In FA (Factory Automation), a plurality of instruments such as motors or actuators are operated in coordination with one another.

To improve the processing accuracy of products in FA, it is desirable that the operation timings of each instrument are highly accurate.

Generally, to control the operation timings of instruments in FA, a clock is provided in each instrument and each instrument is used in accordance with the time on the clock.

The existing art for controlling the operation timings of each instrument will be described hereinafter.
(1) Each instrument is connected to a network.
(2) An instrument called a master notifies time to other instruments (hereinafter, slaves) through the network.
(3) Each slave who has received the time of the master adjusts the time of the clock to the time of the master.
(4) The master notifies each slave of an operation command and an execution time through the network.
(5) When the execution time arrives, each slave operates according to the operation command.

The operation timings of each instrument are controlled as described above.

FIG. 11 is a sequence diagram illustrating a time synchronization method according to the existing art.

The time synchronization method according to the existing art (see Non-Patent Literature 1) will be described with reference to FIG. 11.

In the following description, a master and a slave communicate a frame through a relay device.

A time required by the relay device for a process to relay the frame is a relay time Td, and a time required for propagation of the frame through a communication cable is a propagation time Tp.

Specific examples of time of the master are indicated under “Tm” in FIG. 11, and specific examples of time of the slave are indicated under “Ts” in FIG. 11.

(1) At time Tm1, the master transmits a Sync frame including time Tm1 of the master to the slave through the relay device.

(2) The slave receives the Sync frame. The time of the slave when the slave receives the Sync frame is “Ts1”.

Based on time Tm1 of the master included in the Sync frame, the slave corrects time Ts1 of the slave to time Ts2. Time Ts2 can be represented by the following Equation (a).

Ts2=Ts1−(Ts1−Tm1) Equation (a)

At this time, time Ts2 of the slave is behind time Tm1 of the master by a delay time (Td+Tp) which is a sum of the relay time Td of the relay device and the propagation time Tp of the network. That is, a relation of the following Equation (b) holds.

Ts2=Tm1+(Td+Tp) Equation (b)

(3) The slave transmits a Delay_Req frame for measuring the delay time (Td+Tp) to the master through the relay device.

The time of the slave when the slave transmits the Delay_Req frame is “Ts3”, and the time of the master at that time is “Tm3”.

(4) The master receives the Delay_Req frame. The time of the master when the master receives Delay_Req is “Tm4”. Time Tm4 can be represented by the following Equation (c).

Tm4(=Tm3+(Td+Tp)) Equation (c)

(5) The master transmits a Delay_Resp frame including time Tm4 which is the time when the Delay_Req frame is received to the slave through the relay device.

(6) The slave receives the Delay_Resp frame. Based on time Tm4 of the master included in the Delay_Resp frame, the slave calculates the delay time (Td+Tp) as described below.

(6-1) The time of the master when the slave transmits the Delay_Req frame is “Tm3”. Time Tm3 can be represented by the following Equation (d).

Tm3=Ts3+(Td+Tp) Equation (d)

(6-2) When the above Equation (d) is substituted in the above Equation (c), the following Equation (e) is obtained.

Tm4=(Ts3+(Td+Tp))+(Td+Tp)=Ts3+2(Td+Tp) Equation (e)

From the above Equation (e), the following Equation (f) is obtained.

Tm4−Ts3=2(Td+Tp) Equation (f)

Therefore, the delay time (Td+Tp) can be represented by the following Equation (g).

(Td+Tp)=(Tm4−Ts3)/2 Equation (g)

(7) The slave corrects time Ts4 of the slave to time Ts5 by advancing time Ts4 by the delay time (Td+Tp). Time Ts5 can be represented by the following Equation (h).

Ts5=Ts4+(Td+Tp)=Ts4+(Tm4−Ts3)/2 Equation (h)

With the above process, time Tm5 of the master and time Ts5 of the slave are synchronized.

For example, in the case of the times indicated under “Tm” and “Ts” in FIG. 11, time Tm5 of the master and time Ts5 of the slave both become “390”.

The time synchronization method as illustrated in FIG. 11 is called PTP (Precision Time Protocol).

However, the existing time synchronization method (PTP) is based on the assumption that the relay time Td for the frame does not fluctuate. Thus, if the relay time Td for the frame fluctuates, synchronization accuracy is reduced.

FIG. 12 is a sequence diagram illustrating time misalignment by the time synchronization method according to the existing art.

For example, with the existing time synchronization method (PTP), the time of the master and the time of the slave are misaligned as illustrated in FIG. 12.

In FIG. 12, the delay time for the Delay_Req frame fluctuates by “ΔTd” with respect to the delay time (Td+Tp) for the Sync frame.

That is, the delay time for the Delay_Req frame is “Td+ΔTd+Tp”.

In this case, time Tm3 of the master when the slave transmits the Delay_Req frame is represented by the following Equation (d) as in the case of FIG. 11.

Tm3=Ts3+(Td+Tp) Equation (d)

However, time Tm4 of the master when the master receives the Delay_Req frame is different from that in FIG. 11 and is represented by the following Equation (i).

Tm4=Tm3+(Td+ΔTd+Tp) Equation (i)

When the above Equation (d) is substituted in the above Equation (i), the following Equation (j) is obtained.

(Td+Tp)=(Tm4−Ts3)/2−ΔTd/2 Equation (j)

That is, the delay time (Td+Tp) differs between FIG. 11 and FIG. 12 by “−ΔTd/2”.

For this reason, if the slave corrects time Ts4 of the slave to time Ts5 using Equation (h) as in FIG. 11, time Ts5 of the slave is ahead of time tm5 of the master by “ΔTd/2”.

For example, under “Tm” in FIG. 12, the delay time (Td+Tp) for the Sync frame is “50” and the delay time (Td+ΔTd+Tp) for the Delay_Req frame is “70”. Thus, a delay time fluctuation amount ΔTd is “20 (=70−50)”.

In this case, time Ts5 (=400) of the slave is ahead of time Tm5 (=390) of the master by “10 (=20/2)”.

FIG. 13 is a diagram illustrating in outline a frame relay method according to the existing art.

For example, the relay time Td for the frame fluctuates to “Td+ΔTd” when the transmission timings of frames collide as illustrated in FIG. 13.

In FIG. 13, when the relay device receives the Delay_Req frame from the slave, the relay device is transmitting a frame F.

In this case, the relay device cannot transmit the Delay_Req frame to the master until transmission of the frame F is completed.

For this reason, the relay time for the Delay_Req frame is prolonged by the time ΔTd until transmission of the frame F is completed, thus fluctuating to “Td+ΔTd”.

### CITATION LIST

### Non-Patent Literature

Non-Patent Literature 1: IEEE Std 1588-2008 (Revision of IEEE Std 1588-2002), “IEEE Standard for a Precision Clock Synchronization Protocol for Networked Measurement and Control Systems”, issued on Jul. 24, 2008, p.c 1-269

### SUMMARY OF INVENTION

### Technical Problem

It is an object of the present invention, for example, to prevent a fluctuation in a relay time required for relaying a synchronization frame.

### Solution to Problem

A relay device according to the present invention includes
a frame receiving unit that receives a synchronization frame to be communicated to synchronize time of a first communication device and time of a second communication device, from the first communication device;
a buffer unit that stores the synchronization frame received by the frame receiving unit;
an elapsed time measurement unit that measures an elapsed time that has elapsed from when the synchronization frame is received by the frame receiving unit;
an elapsed time determination unit that determines whether or not the elapsed time measured by the elapsed time measurement unit has reached a fixed delay time for delaying transmission of the synchronization frame; and
a frame transmission unit that transmits the synchronization frame stored in the buffer unit to the second communication device when the elapsed time determination unit determines that the elapsed time has reached the fixed delay time.

### Advantageous Effects of Invention

According to the present invention, for example, it is possible to prevent a fluctuation in a relay time required for relaying a synchronization frame.

### BRIEF DESCRIPTION OF DRAWINGS

FIG. 1 is a configuration diagram of a communication system 100 according to a first embodiment;

FIG. 2 is a configuration diagram of a relay device 200 according to the first embodiment;

FIG. 3 is a flowchart illustrating a frame relay process of the relay device 200 according to the first embodiment;

FIG. 4 is a flowchart illustrating a frame output process (S140) of a buffer unit 220 according to the first embodiment;

FIG. 5 is a table illustrating operations of the buffer unit 220 according to the first embodiment;

FIG. 6 is a diagram illustrating in outline a frame relay method according to the first embodiment;

FIG. 7 is a sequence diagram illustrating an example of a time synchronization procedure of the communication system 100 according to the first embodiment;

FIG. 8 is a diagram illustrating an example of hardware resources of the relay device 200 according to the first embodiment;

FIG. 9 is a configuration diagram of the relay device 200 according to a second embodiment;

FIG. 10 is a diagram illustrating a fixed delay time table 281 according to the second embodiment;

FIG. 11 is a sequence diagram illustrating a time synchronization method according to the existing art;

FIG. 12 is a sequence diagram illustrating time misalignment by the time synchronization method according to the existing art; and

FIG. 13 is a diagram illustrating in outline a frame relay method according to the existing art.

### DESCRIPTION OF EMBODIMENTS

### First Embodiment

An embodiment will be described which prevents a fluctuation in a relay time required for relaying a synchronization frame.

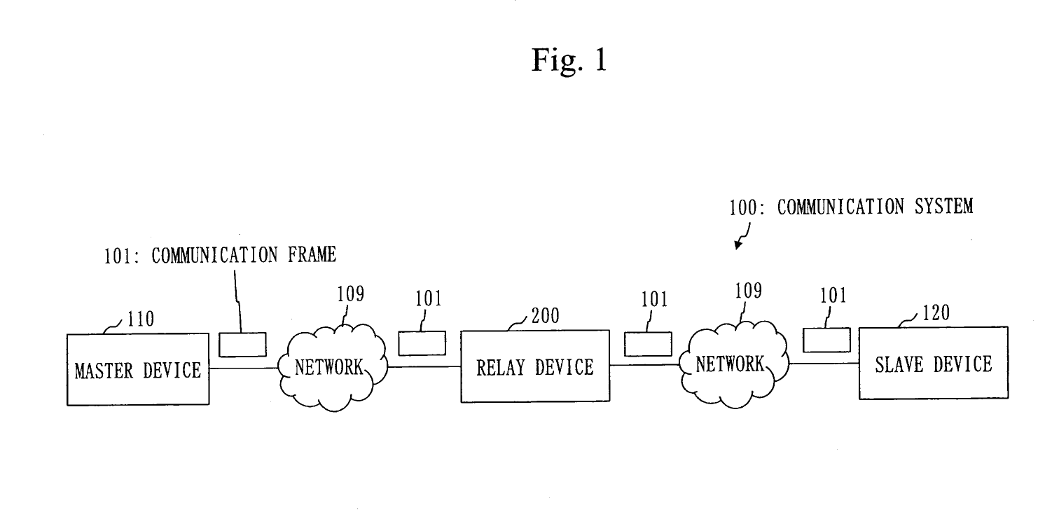

FIG. 1 is a configuration diagram of a communication system 100 according to a first embodiment.

The configuration of the communication system 100 according to the first embodiment will be described with reference to FIG. 1.

The communication system 100 is a network system for communication of a communication frame 101 (also referred to as a communication packet or communication data) through a network 109.

The communication system 100 includes a master device 110, a slave device 120, and a relay device 200.

The master device 110 and the slave device 120 are communication devices that communicate a communication frame 101 by synchronizing times with each other.

A communication frame 101 to be communicated for time synchronization will be referred to as a “synchronization frame”, and a frame other than the synchronization frame will be referred to as a “regular frame” hereinafter.

The relay device 200 is a communication device that relays a communication frame 101 between the master device 110 and the slave device 120.

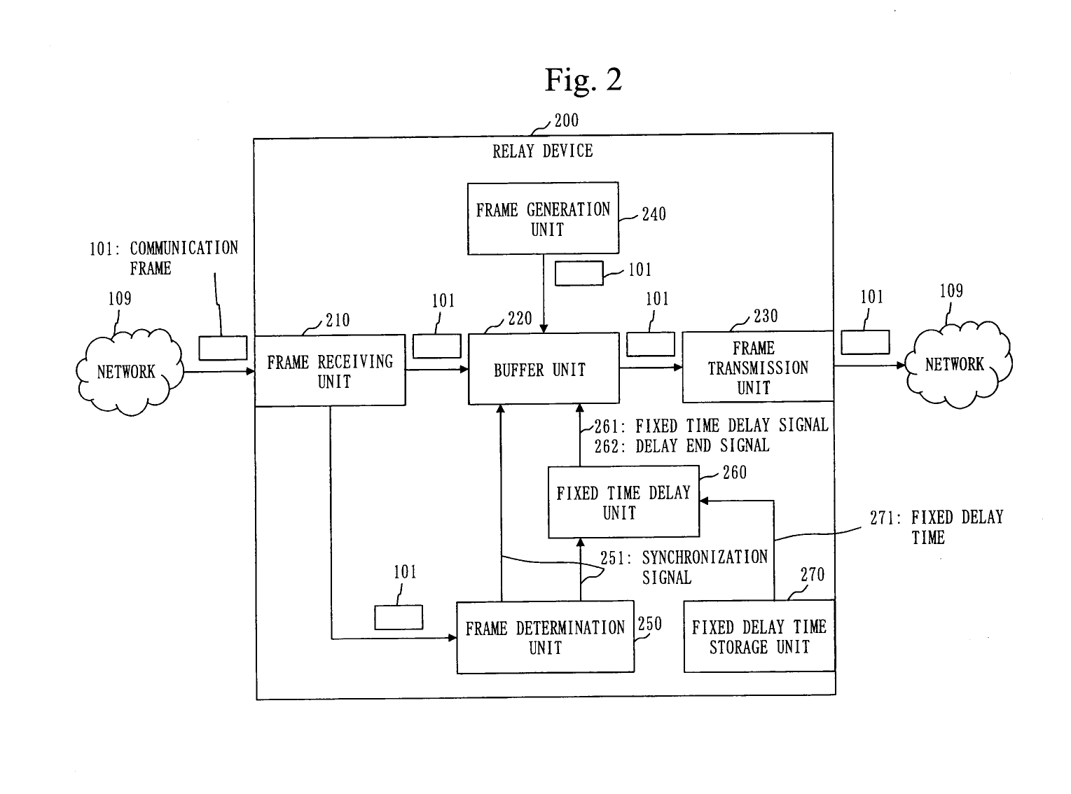

FIG. 2 is a configuration diagram of the relay device 200 according to the first embodiment.

The configuration of the relay device 200 according to the first embodiment will be described with reference to FIG. 2.

The relay device 200 includes a frame receiving unit 210, a buffer unit 220, a frame transmission unit 230, a frame generation unit 240, a frame determination unit 250, a fixed time delay unit 260 (an example of an elapsed time measurement unit and an elapsed time determination unit), and a fixed delay time storage unit 270.

The frame receiving unit 210 is configured to receive a communication frame 101 from the network 109.

The buffer unit 220 is configured to temporarily store a communication frame 101.

The frame transmission unit 230 is configured to transmit a communication frame 101 to the network 109.

The frame generation unit 240 is configured to generate a communication frame 101 (regular frame).

The frame determination unit 250 is configured to determine whether the type of the communication frame 101 received by the frame receiving unit 210 is a regular frame or a synchronization frame.

If the communication frame 101 is a synchronization frame, the frame determination unit 250 outputs a synchronization signal 251 to notify that the communication frame 101 is a synchronization frame to the buffer unit 220 and the fixed time delay unit 260.

The fixed time delay unit 260 is configured to delay transmission of the synchronization frame by a fixed amount of time. The fixed amount of time to delay transmission of the synchronization frame will be referred to as a “fixed delay time 271” hereinafter.

The fixed time delay unit 260 outputs a fixed time delay signal 261 to notify that it is waiting for the fixed delay time 271 to elapse to the buffer unit 220 until the fixed delay time 271 elapses.

When the fixed delay time 271 has elapsed, the fixed time delay unit 260 outputs a delay end signal 262 to notify that the fixed delay time 271 has elapsed to the buffer unit 220.

The fixed delay time storage unit 270 is configured to store the fixed delay time 271.

The fixed delay time 271 is a time which is equal to or greater than a maximum transmission time required by the frame transmission unit 230 from start to completion of transmission of a communication frame 101.

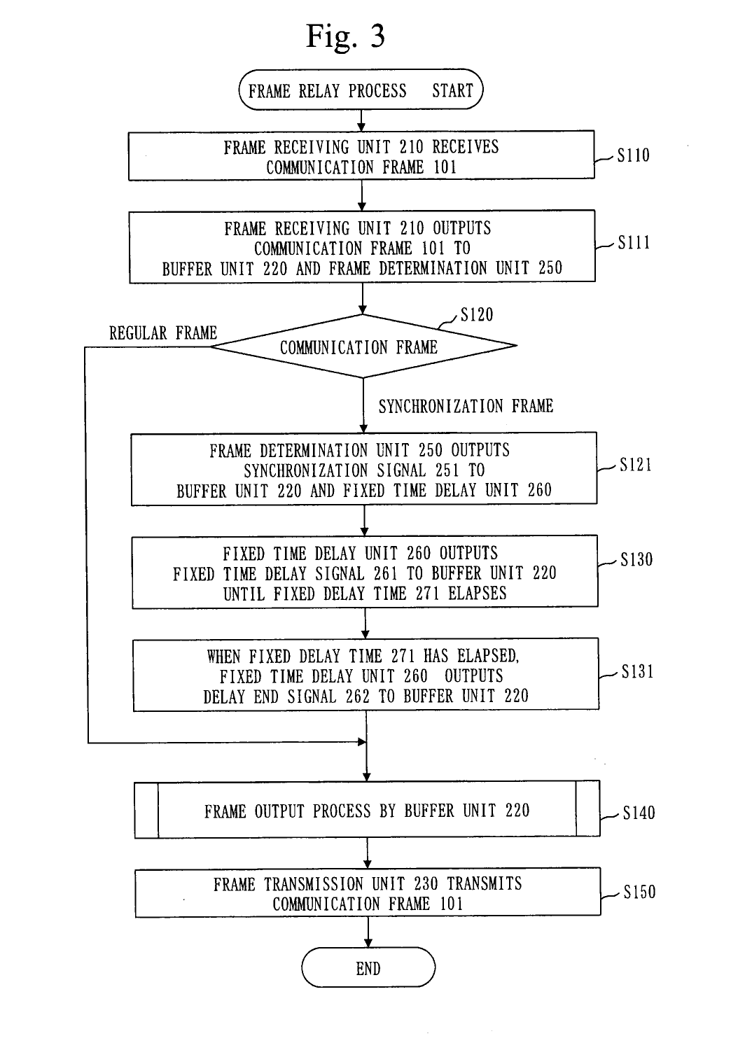

FIG. 3 is a flowchart illustrating a frame relay process of the relay device 200 according to the first embodiment.

The frame relay process of the relay device 200 according to the first embodiment will be described with reference to FIG. 3.

The relay device 200 executes the frame relay process illustrated in FIG. 3 each time the frame receiving unit 210 receives a communication frame 101.

In S110, the frame receiving unit 210 receives a communication frame 101 from the network 109.

After S110, processing proceeds to S111.

In S111, the frame receiving unit 210 outputs the received communication frame 101 to the buffer unit 220 and the frame determination unit 250.

The buffer unit 220 stores the communication frame 101 that is outputted from the frame receiving unit 210 in a communication buffer.

For example, the buffer unit 220 stores the communication frame 101 and a frame type flag indicating the type of the communication frame 101, by associating the communication frame 101 and the flame type flag with each other. At this time, the initial value of the frame type flag is set to a flag value indicating a regular frame.

After S111, processing proceeds to S120.

In S120, the frame determination unit 250 determines whether the type of the communication frame 101 that is outputted from the frame receiving unit 210 is a synchronization frame or a regular frame.

For example, the communication frame 101 includes, in a frame header, a frame type flag indicating whether the type of frame is a synchronization frame or a regular frame. The frame determination unit 250 refers to the frame header of the communication frame 101, and determines the type of the communication frame 101 based on the flag value of the frame type flag which is set in the frame header. Note that the frame determination unit 250 may determine the type of the communication frame 101 by other methods.

If the communication frame 101 is a synchronization frame, processing proceeds to S121.

If the communication frame 101 is a regular frame, processing proceeds to S140.

In S121, the frame determination unit 250 outputs the synchronization signal 251 to the buffer unit 220 and the fixed time delay unit 260.

When the synchronization signal 251 is outputted from the frame determination unit 250, the buffer unit 220 holds the communication frame 101 stored in S111 as a synchronization frame.

For example, the buffer unit 220 stores the communication frame 101 (synchronization frame) and a frame type flag by associating the communication frame 101 and the frame type flag with each other, and sets a flag value indicating a synchronization frame in the frame type flag.

After S121, processing proceeds to S130.

In S130, the fixed time delay unit 260 starts to measure an elapsed time when the synchronization signal 251 is outputted from the frame determination unit 250.

Then, the fixed time delay unit 260 determines whether or not the elapsed time has reached the fixed delay time 271 every time a unit of elapsed time (for example, 0.1 seconds) has elapsed.

The fixed time delay unit 260 continues to output the fixed time delay signal 261 to the buffer unit 220 until the elapsed time reaches the fixed delay time 271.

That is, the fixed time delay unit 260 measures the elapsed time that has elapsed from when the synchronization frame is received, and continues to output the fixed time delay signal 261 to the buffer unit 220 until the measured elapsed time reaches the fixed delay time 271.

For example, the fixed time delay unit 260 obtains from the fixed delay time storage unit 270 a fixed delay count value which is predetermined as the fixed delay time 271. The fixed time delay unit 260 starts a countdown from the fixed delay count value. The fixed time delay unit 260 continues to output the fixed time delay signal 261 to the buffer unit 220 until the fixed delay count value reaches zero.

Note that the fixed time delay unit 260 may count up the count from zero and continue to output the fixed time delay signal 261 to the buffer unit 220 until the count reaches the fixed delay count value. Alternatively, the fixed time delay unit 260 may measure the elapsed time by other methods.

When it is determined that the elapsed time has reached the fixed delay time 271, processing proceeds to S131.

In S131, the fixed time delay unit 260 stops the measurement of the elapsed time and outputs the delay end signal 262 to the buffer unit 220.

After S131, processing proceeds to S140.

In S140, the buffer unit 220 outputs the communication frame 101 to the frame transmission unit 230 by a frame output process to be described later.

After S140, processing proceeds to S150.

In S150, the frame transmission unit 230 transmits the communication frame 101 that is outputted from the buffer unit 220 to the network 109.

After S150, the frame relay process ends.

In the above S120, if the communication frame 101 is a regular frame, the frame determination unit 250 may output a regular signal to notify that the communication frame 101 is a regular frame to the buffer unit 220.

When the regular signal is outputted from the frame determination unit 250, the buffer unit 220 holds the communication frame 101 stored in S111 as a regular frame.

For example, the buffer unit 220 stores the communication frame 101 (regular frame) and a frame type flag by associating the communication frame 101 and the frame type flag with each other, and sets a flag value indicating a regular frame in the frame type flag.

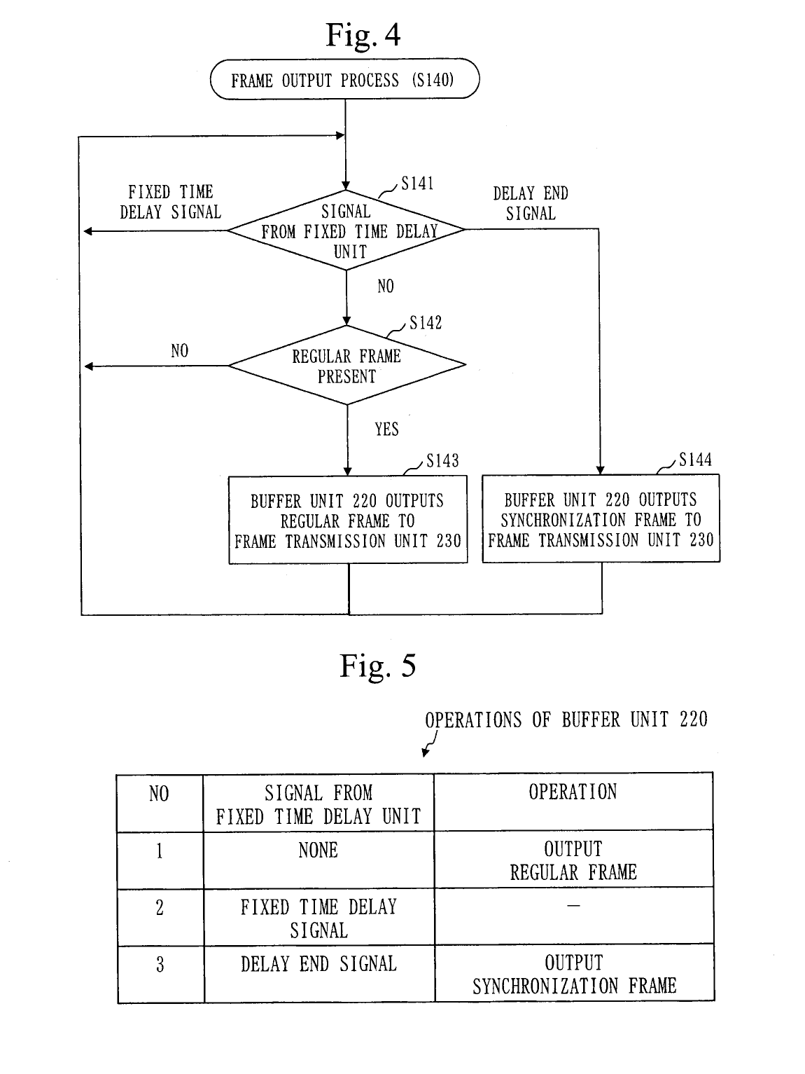

FIG. 4 is a flowchart illustrating the frame output process (S140) of the buffer unit 220 according to the first embodiment.

The frame output process (S140) of the buffer unit 220 according to the first embodiment will be described with reference to FIG. 4.

The buffer unit 220 executes the frame output process (S140) illustrated in FIG. 4 repeatedly.

In S141, the buffer unit 220 determines whether or not the fixed time delay signal 261 or the delay end signal 262 is outputted from the fixed, time delay unit 260.

If the fixed time delay signal 261 is outputted from the fixed time delay unit 260, processing does not transition.

If the delay end signal 262 is outputted from the fixed time delay unit 260, processing proceeds to S144.

If neither the fixed time delay signal 261 nor the delay end signal 262 is outputted from the fixed time delay unit 260, processing proceeds to S142.

In S142, the buffer unit 220 determines whether or not a regular frame is stored.

For example, the buffer unit 220 determines whether or not there is a communication frame 101 which is stored with the flag value indicating a regular frame.

If a regular frame is stored, processing proceeds to S143.

If a regular frame is not stored, processing returns to S141.

In S143, the buffer unit 220 outputs the stored regular frame to the frame transmission unit 230, and deletes the regular frame from the communication buffer. If a plurality of regular frames are stored, the buffer unit 220 outputs the first stored regular frame to the frame transmission unit 230.

After S143, processing returns to S141.

In S144, the buffer unit 220 outputs the stored synchronization frame to the frame transmission unit 230, and deletes the synchronization frame from the communication buffer.

That is, even if a regular frame is stored in addition to a synchronization frame, the buffer unit 220 outputs the synchronization frame to the frame transmission unit 230 in priority to the regular frame.

For example, a communication frame 101 that is stored with the flag value indicating a synchronization frame is a synchronization frame.

After S144, processing returns to S141.

FIG. 5 is a table illustrating operations of the buffer unit 220 according to the first embodiment.

The operations of the buffer unit 220 according to the first embodiment will be described with reference to FIG. 5.

(1) When neither the fixed time delay signal 261 nor the delay end signal 262 is outputted from the fixed time delay unit 260, the buffer unit 220 outputs a regular frame to the frame transmission unit 230.
(2) While the fixed time delay signal 261 is being outputted from the fixed time delay unit 260, the buffer unit 220 does not output any communication frame 101 of a regular frame and a synchronization frame to the frame transmission unit 230.

(3) When the delay end signal 262 is outputted from the fixed time delay unit 260, the buffer unit 220 outputs a synchronization frame to the frame transmission unit 230.

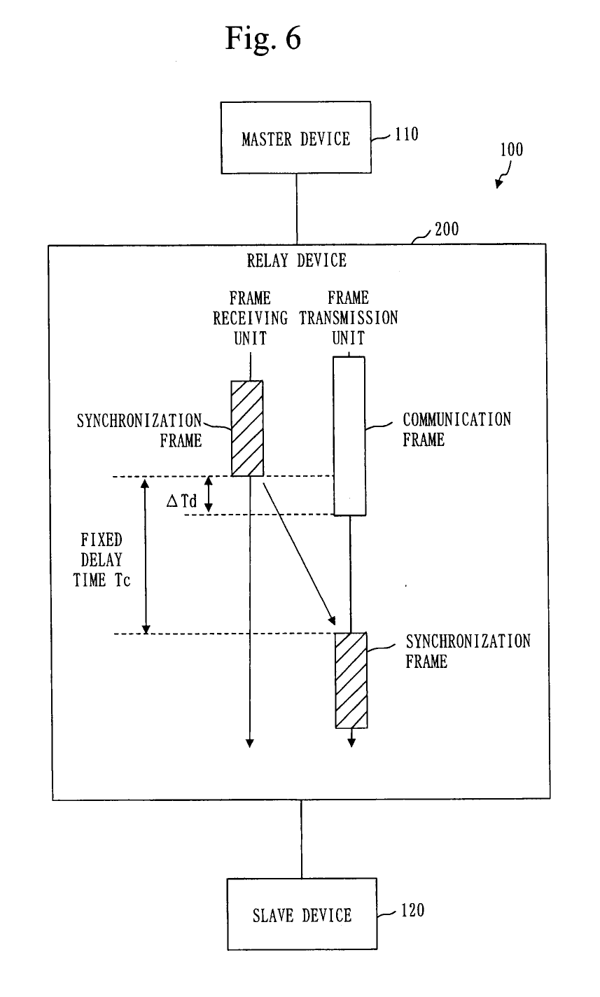

FIG. 6 is a diagram illustrating in outline a frame relay method according to the first embodiment.

The frame relay method according to the first embodiment will be described in outline with reference to FIG. 6.

When a fixed delay time Tc has elapsed from when a synchronization frame Fs is received, the relay device 200 transmits the synchronization frame Fs regardless of whether or not there is a communication frame Fc being transmitted.

The fixed delay time Tc is a time which is equal to or greater than a maximum transmission time required by the frame transmission unit 230 from start to completion of transmission of a communication frame 101.

For example, it is assumed that a maximum frame size is specified by a regulation for the communication frame Fc to be communicated by the master device 110 and the slave device 120. The communication frame Fc of the maximum frame size will be referred to as a “maximum frame”.

In this case, the fixed delay time Tc is a time which is equal to or greater than a transmission time required by the frame transmission unit 230 from start to completion of transmission of the maximum frame.

Therefore, with respect to a wait time ΔTd from receipt of the synchronization frame Fs to completion of transmission of the communication frame Fc, a relation “fixed delay time Tc≧wait time ΔTd” holds.

That is, the transmission of the communication frame Fc is completed by the time when the fixed delay time Tc elapses from receipt of the synchronization frame Fs.

For this reason, the delay time from receipt of the synchronization frame Fs to start of transmission of the synchronization frame Fs is invariably the fixed delay time Tc.

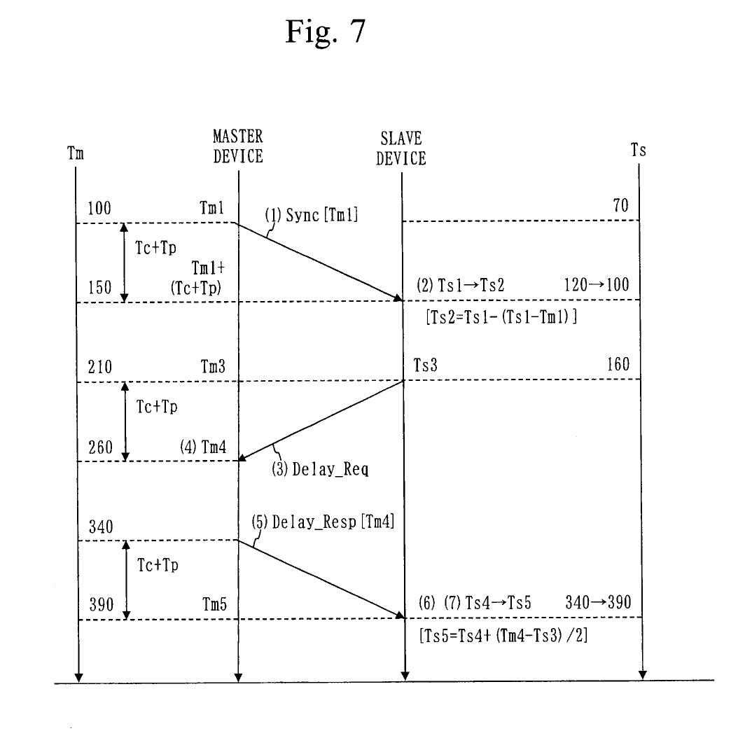

FIG. 7 is a sequence diagram illustrating an example of a time synchronization procedure of the communication system 100 according to the first embodiment.

For example, when the time synchronization method (PTP: Precision Time Protocol) described in Non-Patent Literature 1 is used, the master device 110 and the slave device 120 are synchronized with each other as described below.

Specific examples of time of the master device 110 are indicated under “Tm” in FIG. 7, and specific examples of time of the slave device 120 are indicated under “Ts” in FIG. 7.

(1) At time Tm1, the master device 110 transmits a Sync frame including time Tm1. The relay device 200 (illustration omitted) relays the Sync frame to the slave device 120.

(2) The slave device 120 receives the Sync frame. The time of the slave device 120 when the slave device 120 receives the Sync frame is “Ts1”.

Based on time Tm1 of the master device 110 included in the Sync frame, the slave device 120 corrects time Ts1 of the slave device 120 to time Ts2. Time Ts2 can be represented by the following Equation (A).

Ts2=Ts1−(Ts1−Tm1) Equation (A)

At this time, time Ts2 of the slave device 120 is behind time Tm1 of the master device 110 by a delay time (Tc+Tp) which is a sum of the fixed delay time Tc of the relay device 200 and a propagation time Tp of the network 109. That is, a relation of the following Equation (B) holds.

Ts2=Tm1+(Tc+Tp) Equation (B)

(3) The slave device 120 transmits a Delay_Req frame for measuring the delay time (Tc+Tp). The relay device 200 relays the Delay_Req frame to the master device 110.

The time of the slave device 120 when the slave device 120 transmits the Delay_Req frame is “Ts3”, and the time of the master device 110 at that time is “Tm3”.

(4) The master device 110 receives the Delay_Req frame. The time of the master device 110 when the master device 110 receives Delay_Req is “Tm4”. Time Tm4 can be represented by the following Equation (C).

Tm4(=Tm3+(Tc+Tp)) Equation (C)

(5) The master device 110 transmits a Delay_Resp frame including time Tm4 which is the time when the Delay_Req frame is received. The relay device 200 relays the Delay_Resp frame to the slave device 120.

(6) The slave device 120 receives the Delay_Resp frame. Based on time Tm4 of the master device 110 included in the Delay_Resp frame, the slave device 120 calculates the delay time (Tc+Tp) as described below.

(6-1) The time of the master device 110 when the slave device 120 transmits the Delay_Req frame is “Tm3”. Time Tm3 can be represented by the following Equation (D).

Tm3=Ts3+(Tc+Tp) Equation (D)

(6-2) When the above Equation (D) is substituted in the above Equation (C), the following Equation (E) is obtained.

Tm4=(Ts3+(Tc+Tp))+(Tc+Tp)=Ts3+2(Tc+Tp) Equation (E)

From the above Equation (E), the following Equation (F) is obtained.

Tm4−Ts3=2(Tc+Tp) Equation (F)

Therefore, the delay time (Tc+Tp) can be represented by the following Equation (G).

(Tc+Tp)=(Tm4−Ts3)/2 Equation (G)

(7) The slave device 120 corrects time Ts4 to time Ts5 by advancing time Ts4 by the delay time (Tc+Tp). Time Ts5 can be represented by the following Equation (H).

Ts5=Ts4+(Tc+Tp)=Ts4+(Tm4−Ts3)/2 Equation (H)

With the above process, time Tm5 of the master device 110 and time Ts5 of the slave device 120 are synchronized.

For example, in the case of the times indicated under “Tm” and “Ts” in FIG. 7, time Tm5 of the master device 110 and time Ts5 of the slave device 120 both become “390”.

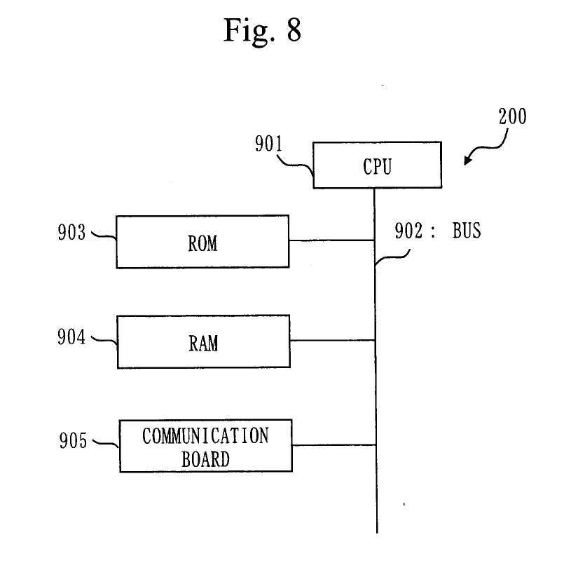

FIG. 8 is a diagram illustrating an example of hardware resources of the relay device 200 according to the first embodiment.

Referring to FIG. 8, the relay device 200 (an example of a computer) includes a CPU 901 (Central Processing Unit). The CPU 901 is connected, through a bus 902, to hardware devices such as a ROM 903, a RAM 904, and a communication board 905, and controls these hardware devices.

The ROM 903 and the RAM 904 are examples of a buffer or a storage device.

The communication board 905 is connected with a wire or wirelessly to a communication network such as a LAN (Local Area Network), the Internet, and a telephone line.

The storage device such as the ROM 903 or the RAM 904 stores an OS (operating system), programs, and files.

The programs include programs that execute each function described as a “unit” in the embodiments. The programs (for example, a relay program) are read out and executed by the CPU 901. That is, the programs cause a computer to function as each “unit”, or cause the computer to execute a procedure and a method of each “unit”.

The files include various types of data (an input, an output, a determination result, a computation result, a processing result, etc.) to be used in each “unit” described in the embodiments.

In the embodiments, arrows included in the configuration diagrams and the flowcharts mainly denote data and inputs/outputs of signals.

The processes of the embodiments that are described based on the flowcharts or the like are executed using hardware (for example, the CPU 901).

A component described as a “unit” in the embodiments may be a “circuit”, a “device”, or “equipment”, and may also be a “step”, a “procedure”, or a “process”. That is, a component described as a “unit” may be implemented by firmware, software, hardware, or a combination of these.

According to the first embodiment, effects as described below can be obtained, for example.

Until the fixed delay time 271 elapses from receipt of a synchronization frame, the relay device 200 does not transmit the synchronization frame or a regular frame. When the fixed delay time 271 has elapsed, the relay device 200 transmits the synchronization frame. That is, the relay device 200 can maintain the relay time required for relaying the synchronization frame to be a fixed time (the fixed delay time 271) and prevent a fluctuation in the relay time for the synchronization frame. The master device 110 and the slave device 120 can accurately synchronize the times with each other by communicating the synchronization frame through the relay device 200.

In the first embodiment, a relay device (200) as described below, for example, has been described. Reference signs or names of corresponding components will be indicated in parentheses.

The relay device includes a frame receiving unit (210), a buffer unit (220), an elapsed time measurement unit (260), an elapsed time determination unit (260), and a frame transmission unit (230).

The frame receiving unit receives a synchronization frame to be communicated to synchronize time of a first communication device (110) and time of a second communication device (120), from the first communication device (S110).

The buffer unit stores the synchronization frame received by the frame receiving unit (S111).

The elapsed time measurement unit measures an elapsed time that has elapsed from when the synchronization frame is received by the frame receiving unit (S130).

The elapsed time determination unit determines whether or not the elapsed time measured by the elapsed time measurement unit has reached a fixed delay time (171) for delaying transmission of the synchronization frame (S130).

When the elapsed time determination unit determines that the elapsed time has reached the fixed delay time, the frame transmission unit transmits the synchronization frame stored in the buffer unit to the second communication device (S144, S150).

The relay device includes a fixed delay time storage unit (170) that stores the fixed delay time which is predetermined as a time equal to or greater than a time required for transmission of a regular frame which is a frame other than the synchronization frame.

The frame receiving unit receives the regular frame (S110).

The buffer unit stores the regular frame received by the frame receiving unit (S111).

The frame transmission unit starts transmission of the regular frame stored in the buffer unit (S143, S150).

When the synchronization frame is received by the frame receiving unit during the transmission of the regular frame, the frame transmission unit completes the transmission of the regular frame before it is determined that the elapsed time that has elapsed from when the synchronization frame is received has reached the fixed delay time (S150).

The elapsed time measurement unit measures the elapsed time from when the synchronization frame is received until when it is determined that the elapsed time has reached the fixed delay time (S130).

When a new regular frame is received by the frame receiving unit, the frame transmission unit does not start transmission of the new regular frame while the elapsed time is being measured by the elapsed time measurement unit (“fixed time delay signal” in S141).

The frame transmission unit transmits the synchronization frame when it is determined that the elapsed time has reached the fixed delay time, and transmits the new regular frame after the synchronization frame is transmitted (S144).

### Second Embodiment

An embodiment will be described which allows the fixed delay time 271 to be changed.

Differences from the first embodiment will be mainly described hereinafter. Description will be omitted for what is substantially the same as in the first embodiment.

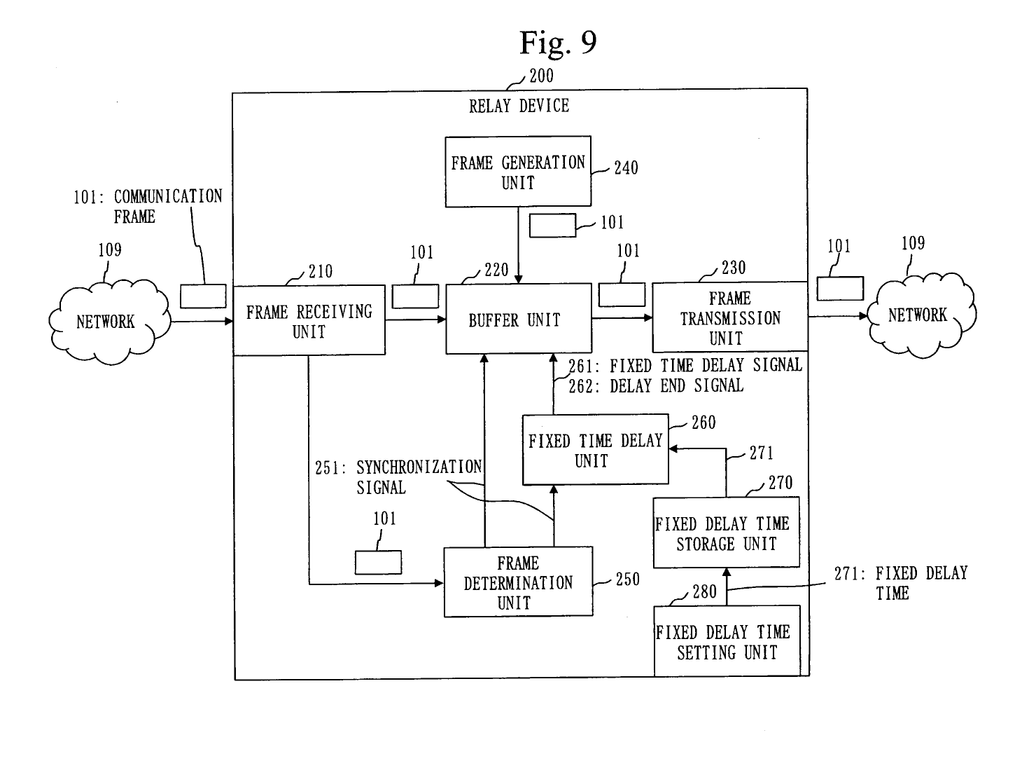

FIG. 9 is a configuration diagram of the relay device 200 according to a second embodiment.

The configuration of the relay device 200 according to the second embodiment will be described with reference to FIG. 9.

The relay device 200 includes a fixed delay time setting unit 280 in addition to the components of the first embodiment (see FIG. 2).

The fixed delay time setting unit 280 is configured to set the fixed delay time 271 in the fixed delay time storage unit 270.

For example, an administrator decides the fixed delay time 271 in accordance with the type of the network 190 in which the relay device 200 is installed, and inputs the decided fixed delay time 271 to the fixed delay time setting unit 280. Then, the fixed delay time setting unit 280 stores the inputted fixed delay time 271 in the fixed delay time storage unit 270.

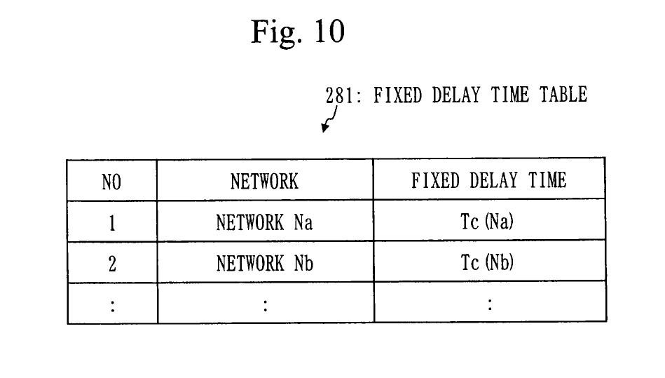

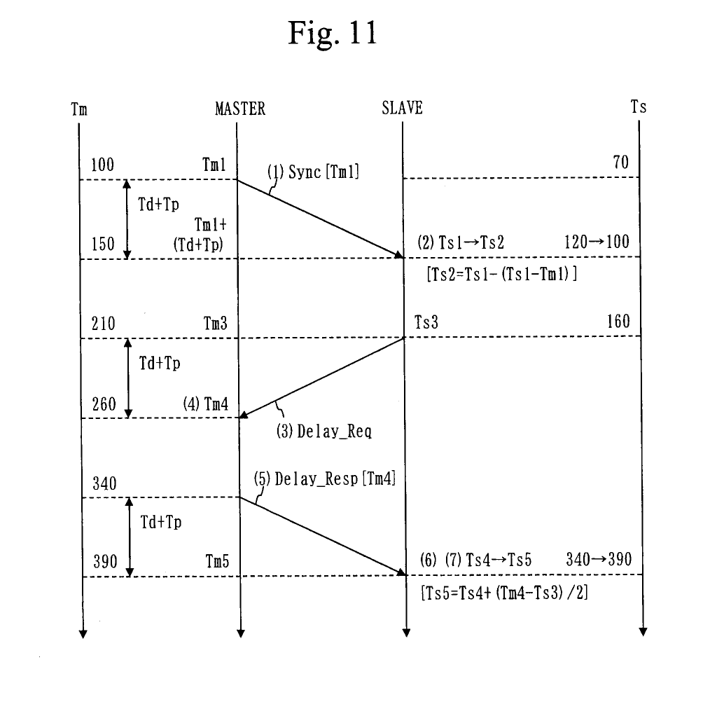

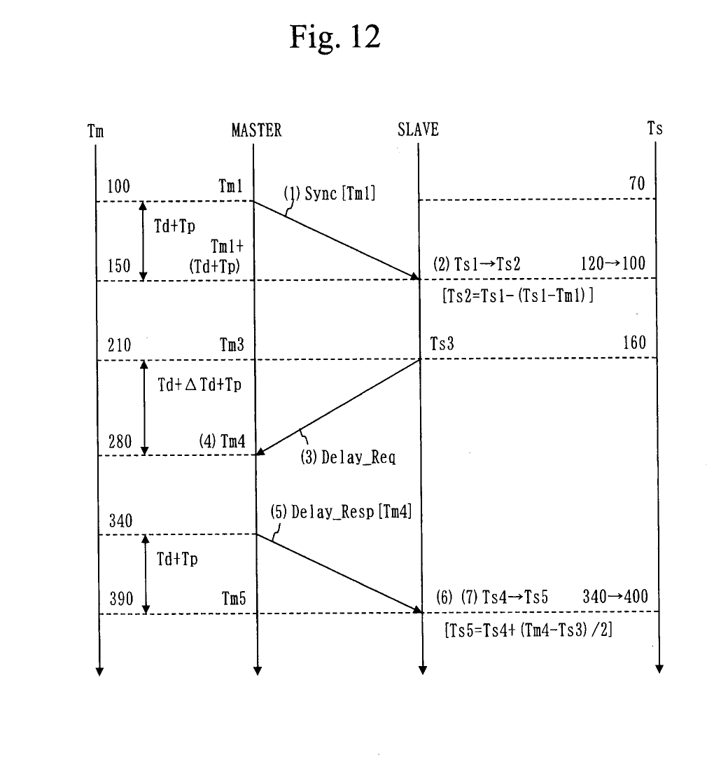

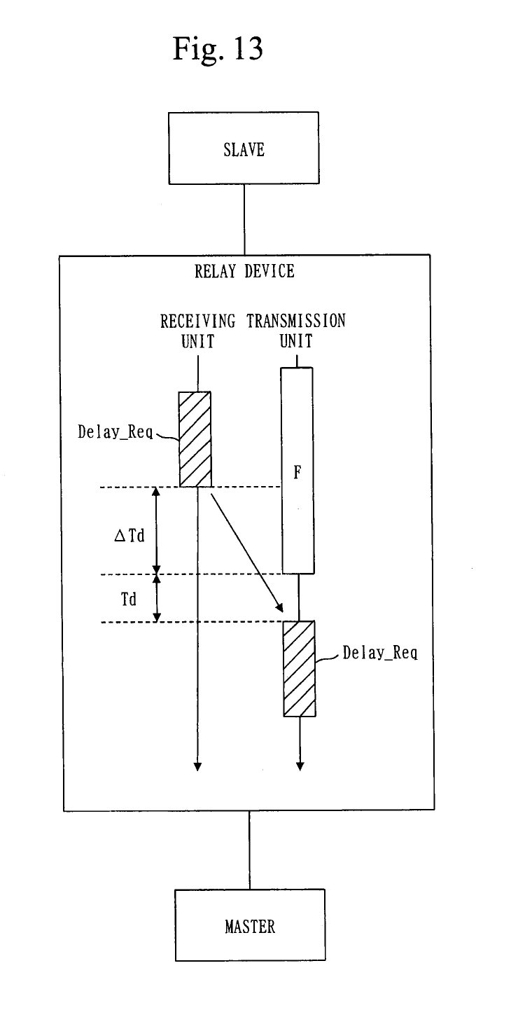

FIG. 10 is a diagram illustrating a fixed delay time table 281 according to the second embodiment.

For example, the fixed delay time setting unit 280 may store the fixed delay time table 281 (an example of a candidate time storage unit) associating a “network” with a “fixed delay time” as illustrated in FIG. 10.

In this case, the administrator inputs to the fixed delay time setting unit 280 a network identifier for identifying the network 109 (or the type of the network 109) in which the relay device 200 is installed.

Then, the fixed delay time setting unit 280 obtains from the fixed delay time table 281 the fixed delay time 271 associated with the inputted network identifier, and stores the obtained fixed delay time 271 in the fixed delay time storage unit 270.

According to the second embodiment, effects as described below can be obtained, for example.

The relay device 200 can change the fixed delay time 271 for the synchronization frame in accordance with the type of the network 109.

In the second embodiment, a relay device (200) as described below, for example, has been described. Reference signs or names of corresponding components will be indicated in parentheses.

The relay device includes a fixed delay time setting unit (280) that causes an inputted input time to be stored in the fixed delay time storage unit (270) as the fixed delay time (271).

The relay device includes a candidate time storage unit (281) and the fixed delay time setting unit (280).

The candidate time storage unit stores a network identifier (for example, Na) for identifying a network (109) and a candidate time (for example, Tc(Na)) which is a candidate for the fixed delay time, by associating the network identifier and the candidate time with each other.

The fixed delay time setting unit obtains from the candidate time storage unit a candidate time which is associated with a network identifier which is the same as an inputted network identifier, and stores the obtained candidate time in the fixed delay time storage unit (270) as the fixed delay time.

### REFERENCE SIGNS LIST

100: communication system, 101: communication frame, 109: network, 110: master device, 120: slave device, 200: relay device, 210: frame receiving unit, 220: buffer unit, 230: frame transmission unit, 240: frame generation unit, 250: frame determination unit, 251: synchronization signal, 260: fixed time delay unit, 261: fixed time delay signal, 262: delay end signal, 270: fixed delay time storage unit, 271: fixed delay time, 280: fixed delay time setting unit, 281: fixed delay time table, 901: CPU, 902: bus, 903: ROM, 904: RAM, 905: communication board

1. A relay device comprising:
a frame receiving circuit that receives a synchronization frame to be communicated to synchronize time of a first communication device and time of a second communication device, from the first communication device;
a buffer that stores the synchronization frame received by the frame receiving circuit;
an elapsed time measurement circuit that measures an elapsed time that has elapsed from when the synchronization frame is received by the frame receiving circuit;
an elapsed time determination circuit that determines whether or not the elapsed time measured by the elapsed time measurement circuit has reached a fixed delay time for delaying transmission of the synchronization frame;
a frame transmission circuit that transmits the synchronization frame stored in the buffer circuit to the second communication device when the elapsed time determination circuit determines that the elapsed time has reached the fixed delay time;
a fixed delay time memory to store the fixed delay time which is predetermined as a time equal to or greater than a time required for transmission of a regular frame which is a frame other than the synchronization frame;
a candidate time memory to store a network identifier for identifying a network and a candidate time which is a candidate for the fixed delay time, by associating the network identifier and the candidate time with each other; and
a fixed delay time setting circuit that obtains from the candidate time memory a candidate time which is associated with a network identifier which is same as an inputted network identifier, and causes the candidate time obtained to be stored in the fixed delay time memory as the fixed delay time.

2. The relay device according to claim 1,
wherein the frame receiving circuit receives the regular frame,
wherein the buffer stores the regular frame received by the frame receiving circuit,
wherein the frame transmission circuit starts transmission of the regular frame stored in the buffer, and
wherein when the synchronization frame is received by the frame receiving circuit during the transmission of the regular frame, the frame transmission circuit completes the transmission of the regular frame before it is determined that the elapsed time that has elapsed from when the synchronization frame is received has reached the fixed delay time.

3. The relay device according to claim 2,
wherein the elapsed time measurement circuit measures the elapsed time from when the synchronization frame is received until when it is determined that the elapsed time has reached the fixed delay time, and
wherein when a new regular frame is received by the frame receiving circuit, the frame transmission circuit does not start transmission of the new regular frame while the elapsed time is being measured by the elapsed time measurement circuit.

4. The relay device according to claim 3,
wherein the frame transmission circuit transmits the synchronization frame when it is determined that the elapsed time has reached the fixed delay time, and transmits the new regular frame after the synchronization frame is transmitted.

5-6. (canceled)

7. A relay method comprising:
receiving, a synchronization frame to be communicated to synchronize time of a first communication device and time of a second communication device, from the first communication device;
storing the synchronization frame in a buffer;
measuring an elapsed time that has elapsed from when the synchronization frame is received;
determining whether or not the elapsed time has reached a fixed delay time for delaying transmission of the synchronization frame;
transmitting the synchronization frame stored in the buffer to the second communication device it is determined that the elapsed time has reached the fixed delay time;
storing, in a fixed delay time memory, the fixed delay time which is predetermined as a time equal to or greater than a time required for transmission of a regular frame which is a frame other than the synchronization frame;
storing, in a candidate time memory, a network identifier for identifying a network and a candidate time which is a candidate for the fixed delay time, by associating the network identifier and the candidate time with each other; and
obtaining from the candidate time memory a candidate time which is associated with a network identifier which is same as an inputted network identifier, and causing the candidate time obtained to be stored in the fixed delay time memory as the fixed delay time.

8. A relay program that causes a computer to function as the relay device according to claim 1.
